(19) United States
(12) Patent Application Publication
(10) Pub. No.: US 2007/0122538 A1
(43) Pub. Date: May 31, 2007

(54) Compound Butter Sauce

(75) Inventor: David Martin Stemmle, Durham, NC (US)

Correspondence Address: David Stemmle, 1021 Green St, Durham, NC, 27701, US

(73) Assignee: David Martin Stemmle, Durham, NC (US)

(21) Appl. No.: 11/379,212

(22) Filed: Apr. 18, 2006

Related U.S. Application Data
(60) Provisional application No. 60/673,390, filed on Apr. 21, 2005.

(51) Int. Cl. A23L 1/40

(52) U.S. Cl. 426/589

(57) ABSTRACT

The invention discussed herein (compound butter sauce) pertains to a new method for making flavored butter sauces akin to the classical French style “beurre blanc” or beurre rouge.” The process involves a “cold emulsion,” wherein the mixture (a liquid element and a fat element) is fully emulsified by using a wire whip, without reaching the melting point. It is then packaged and refrigerated until used by the consumer. This discovery allows the consumer to use the product with minimal preparation time—about one minute—as opposed to the typical 30 minutes it would take to make the sauce from scratch.

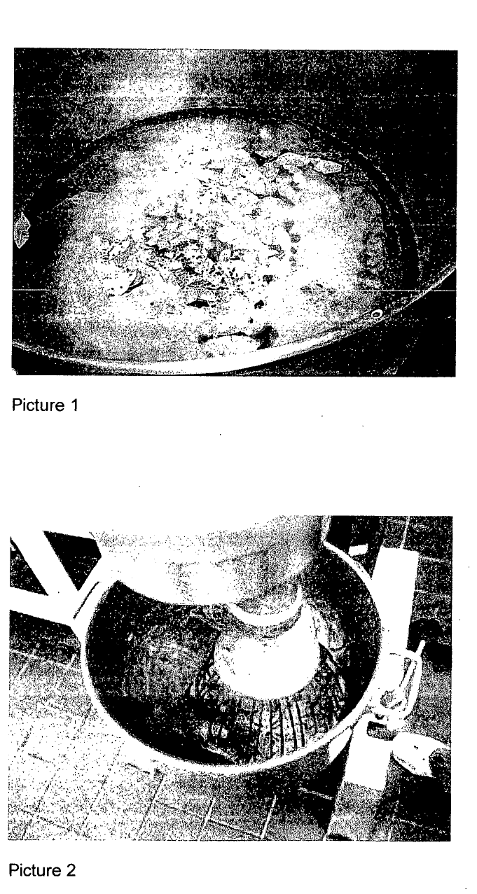

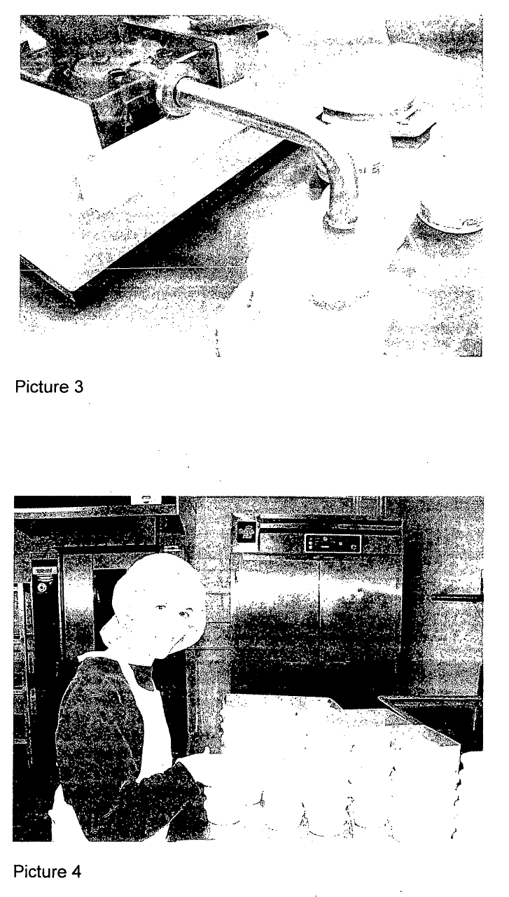

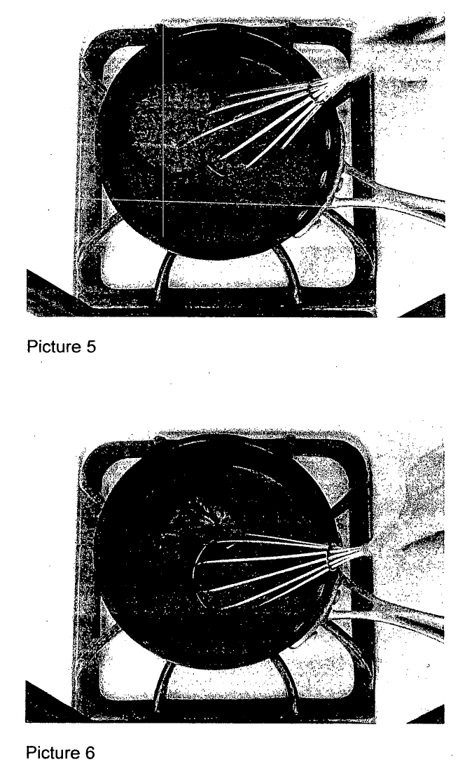

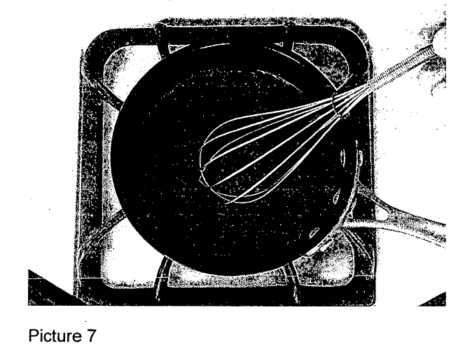

### CROSS REFERENCE TO RELATED APPLICATIONS

This is the non-provisional follow up to provisional application No. 60/673,390

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention is based on several other established constructs: the French “Beurre Blanc” sauce, the “compound butter”, and the “vinaigrette”. The traditional Beurre Blanc is typically a reduction of wine and/or vinegar with shallots to a syrup-like consistency, then emulsified with butter over low heat to create a thick and rich sauce (See Reference 1). Compound butter is made by incorporating a flavoring agent into room temperature buffer, and re-forming the butter to be melted upon freshly prepared hot foods (like a blue cheese butter melting on top of a steak, hot off the grill). (See Reference 2) A vinaigrette is an emulsion of a water element (vinegar) and a fat element (oil). (See reference 3)

The “Compound Butter Sauce” was invented to allow a beurre blanc to be as easily useful as a prepared compound butter by using the same culinary theory behind the vinaigrette. We “compound” the butter with the liquid elements of the beurre blanc.

### BRIEF SUMMARY OF THE INVENTION

The invention is a method of making a cold emulsion compound butter, which is flavored both by reduced (and thus intensified) aromatic liquids (such as wine, stocks, juices etc. see picture 1) and other flavoring agents. This cold emulsion method allows for an “instant” version of classical French style sauces to be quickly and easily prepared by the consumer.

### BRIEF DESCRIPTION OF THE SEVERAL VIEWS OF THE DRAWING

Picture 1: Wine reducing in a steam jacketed kettle with herbs and spices.

Picture 2: Red wine reduction, butter, and flavorings being emulsified in a mixer.

Picture 3: Spicy Orange Creole Sauce being packaged into cups.

Picture 4: Sauces are topped with lids and stickers, then shrink wrapped.

Picture 5: Sauce being prepared by a consumer. It has been added to a pan and gently stirred for about 20 seconds.

Picture 6: Sauce being prepared by a consumer. It has been added to a pan and gently stirred for about 40 seconds.

Picture 7: Sauce being prepared by a consumer. It has been added to a pan and gently stirred for about 60 seconds. It is ready to serve.

### DETAILED DESCRIPTION OF THE INVENTION

This is the non-provisional follow up to provisional application No. 60/673,390.

Compound butter sauces are made by emulsifying butter with an acidic liquid component at room temperature (25° C.) through high-speed whipping (see picture 2). Seasonings and other emulsifying agents such as mustard may also be added to produce a variety of flavors. The product is then packaged (see pictures 3, and 4) and cooled by refrigeration or freezing. It is made ready for consumption by stirring or whisking over low heat for a couple of minutes until melted, at which point it can be poured over a meal as a finishing sauce to add flavor, moisture, and beauty to the food.

The compound butter sauce is exceptionally versatile and can be utilized in a variety of settings. The home cook can use it on any meat, fish or vegetable dish to bring both flavor and beauty. Even if the home cook is familiar with the conventional “hot emulsion” technique to make a sauce like this—they may still prefer to use this invention as a time saver, as it takes over half an hour to make this sauce from scratch (preparation time varies based on technique, recipe and quantity).

A restaurant also may choose to use this cold emulsified sauce as a time saver. The ingredients are costly, as are the wages of employees who in this case would be paid to stand around and watch the liquids boil. Furthermore, kitchen staff at restaurants of low to medium quality may not have the formal training or experience to know how to make such a product for use in their restaurant—this invention would provide an easy and delicious short-cut.

Caterers may also appreciate the versatility of the invention, as they are prone to accept jobs that require them to produce meals in locations that do not have fully functional kitchens. This sauce would be quite easy to prepare using only a buffet pan, and a sterno candle (which are the typical tools of the trade for a caterer). Additionally the same time saving, and wage saving argument would apply to caterers the same as it does to restaurants.

Another possible application for the invention is in the frozen foods industry (including airline food, cafeteria food etc). By placing individual portions of the sauce onto a meal to be frozen and reheated later, an otherwise mundane meal can be turned into something gourmet. The sauce's ability to maintain its integrity when frozen and reheated lends it to usage in frozen meals in a variety of settings including airline/travel industry, and frozen entrees in grocery stores.

Researching the production process for this invention revealed specific ratios of liquid to fat, specific temperatures at all stages of the process, and the proper adjustment of acidity levels. Discovery details are listed below:
The liquid element should not be in excess of 1.25 cups per pound of butter. A higher amount prevents a full emulsion of the liquid into the fat, and leaves drops of the liquid visible on the surface of the product. A liquid amount of one cup per pound of butter appears to be the ideal amount to fully distribute the color and flavor of the liquid elements—though any amount down to a syrup and including flavoring oils and chemical compounds may be used as the flavoring agent.
If the temperature of the product, or the butter to be used in the product exceeds 82.4 degrees (melting temperature according to http://hypertextbook.com/facts/2003/JessicaCheung.shtml), the texture of the product will be compromised, and the quality will decrease. For this reason the product should be stored in refrigeration until consumer use. The consumer will take refrigerated sauce and stir over low heat until melted—about one minute (see pictures 5 to 7)—then pour over a finished meal.
Acidity of the product must be at a pH of 2.5 or higher to ensure high quality (too much acidity can contribute to the breaking of a sauce)—yet the pH must be lower than 4.6 in order to be considered an “acid food”. An “acid food” means that the food product is preserved by the levels of acidity inherent to the product.

### REFERENCES

### Reference #1

A Basic Beurre Blanc:

2 tablespoons white wine vinegar
2 tablespoons dry white wine
1 tablespoon minced shallots
1 to 2 sticks unsalted butter, cold
Salt and pepper to taste

In a saucepan combine vinegar, wine and shallots. Over low to medium heat reduce mixture to about 1 tablespoon of product. Mixture will become like a jam.

Over low heat add dots of cold butter while continually whisking. Continue to add, mount, butter quickly, barely allowing for previously added butter to melt. Mixture will appear frothy and creamy.

Strain sauce (optional). Season with salt and pepper to taste.

http://www.foodnetwork.com/food/recipes/recipe/0,,FOOD₁₃ 9936_{—}3520,00.html

### Reference #2

A Basic Compound Butter:

1 pound butter
3 to 4 tablespoons extra virgin olive oil
2 tablespoons fresh chives, chopped
1 tablespoon thyme, chopped
1 tablespoon sage, chopped
1 tablespoon rosemary, chopped
   Hardware:
Dough scraper
Standing mixer
Parchment paper or plastic wrap

Chop the butter into uniform chunks using the dough scraper.

Place the oil into the food processor and add the chives. Process until the chives are finely chopped. Add the remaining herbs and blend until the herbs have colored the oil. Using the whisk attachment, whip the butter in the mixers work bowl at medium speed until it softens and lightens in color, about 5 to 7 minutes.

Add the herb oil to the butter and beat for another 2 minutes until oil is fully incorporated. Remove butter from bowl and spoon onto parchment paper or plastic wrap. Roll into a log, using the edge of a baking sheet to form a tight log. Chill for 2 hours before serving.

http://www.foodnetwork.com/food/recipes/recipe/0,,FOOD_{—}9936_{—}16230,00.html

### Reference #3

A Basic Vinaigrette:

¼ cup white wine, Champagne, or aged Sherry wine vinegar
2 teaspoons Dijon mustard
1 teaspoon kosher salt
Freshly ground black pepper
⅔ to ¾ cups extra-virgin olive oil

In a small mixing bowl, whisk together the vinegar, mustard, salt, and pepper. Gradually whisk in enough oil to make a smooth dressing with a balanced taste. Use immediately or store covered, in the refrigerator, for up to 1 week.
http://www.foodnetwork.com/food/recipes/recipe/0,,FOOD_{—}9936_{—}19924,00.html

1. An “instant” (ready in one minute) sauce comprised mainly of butter (˜65%), aromatic liquids (˜30%) [which may be intensified through reduction (evaporation of water elements over heat), or by concentration techniques like those employed when making a frozen juice concentrate] and other flavoring agents (˜5%) such as flavored oils, chemicals, condiments, herbs, spices, and mixtures.

2. The compound butter sauce as recited in claim 1 wherein it is emulsified at a temperature no higher than 82.4° F. to ensure that the butter does not melt.

3. The compound butter sauce as reduced in claim 1 wherein each flavor of sauce has an optimal amount of aromatic liquid, which depends on the qualities of that liquid, but which will fall within the range of 0.2 cups to 1.25 cups per pound of butter (example: orange juice must be concentrated to the precise amount or the acidity will cause the sauce to destabilize and separate when prepared).

4. The compound butter sauce as recited in claim 1 wherein emulsifiers and thickeners such as mustard, xantham gum, arrowroot, potato starch, cornstarch etc. may be used to ensure quality of the product, though it is not always necessary.

5. The final product may be refrigerated before use in order to increase the stability of the sauce upon reheating.
